(19) United States
(12) Patent Application Publication
(10) Pub. No.: US 2016/0040786 A1
(43) Pub. Date: Feb. 11, 2016

(54) Aeration butterfly valve

(71) Applicant: David E. Sisk, Bonne Terre, MO (US)

(72) Inventor: David E. Sisk, Bonne Terre, MO (US)

(21) Appl. No.: 14/756,524

(22) Filed: Sep. 14, 2015

Related U.S. Application Data
(63) Continuation of application No. 13/815,780, filed on Mar. 15, 2013.
Application No. 13/815,780 is a continuation-in-part of application No. 29/442,171, filed on Dec. 26, 2012, now Pat. No. D711509.
Application No. 29/442,171 is a continuation-in-part of application No. 13/815,281, filed on Feb. 19, 2013, now Pat. No. 9,057,445.
(60) Provisional application No. 61/634,580, filed on Mar. 2, 2012.

(51) Int. Cl. F16K 1/226; F16K 24/06; F16K 27/02

(52) U.S. Cl. CPC F16K 1/2263; F16K 27/0218; F16K 24/06

(57) ABSTRACT

An aeration butterfly valve including a butterfly disc valve, located within one or more configured valve housings, furnishes a disc valve that rotates about its own axis separate from the axis of rotation of the pivot stems that hold the disc valve in position for manipulation between opening and closure, with respect to the housing in which the disc valve mounts for operation. A ring seal provided within the housing is formed when the housing parts are engaged together, in the assembly of the housing, forcing a portion of the ring seal interiorly, within the housing passage and flow path, and in alignment with the circumferential periphery of the disc valve, to provide for complete sealing closure when the disc valve is pivoted into closure, thereby eliminating the need for the pivot stem and the disc connection to be sealed in their assembly within the aeration butterfly valve.

### CROSS REFERENCE TO RELATED APPLICATION

This continuation patent application claims priority to the continuation-in-part patent application having Ser. No. 13/815,780, filed on Mar. 15, 2013, which claims priority to the continuation-in-part patent application claims priority to the design patent application having Ser. No. 29/442,171, filed on Dec. 26, 2012; and is a continuation-in-part of Ser. No. 13/815,281, filed on Feb. 19, 2013, which claims priority to the provisional patent application having Ser. No. 61/634,580, filed on Mar. 2, 2012, now expired.

### FIELD OF THE INVENTION

This invention relates to an ultra-lightweight aeration butterfly valve, the type that connects directly to an air line used in the pneumatic tank trailer industry, for supplying pressurized air that provides for the conveyance of bulk granular material particularly from a tank trailer or other conveying means during their operations.

### BACKGROUND OF THE INVENTION

Tank trailers have long been used as a means for conveyance of various materials, and particularly the granule type of materials that may be used in the food, chemical, and other industries. Likewise, similar usage has been made of the railroad car, and other means for conveyance, where, for example, bulk granular material may be conveyed, to a distant location, and then unloaded, through a valve means operatively associated with the bottom of the trailer or hopper car. Usually, as the bulk material discharges from the tank trailer, air pressure is used to provide for conveyance of the discharging material, to a distant location, for its further storage or usage. Pressurized air, from an air generating source, passes the air through an air line, and picks up the discharging granular material, for conveying it through a flow line, to another location.

Heretofore, various types of aeration valves have been used in the prior art. For example, a ball type of check valve has been employed frequently, but usually the ball valve will reduce the diameter of the air flow line, for transferring the pressurized air through its ball valve, which causes a disruption in the flow of the pressurized air, and a generated turbulence, which can reduce the efficiency of operation of the pressurized air in moving the granular material. In addition, usually these ball types of check valves, used in air lines, are made of steel, stainless steel, brass, or other heavy metals. Thus, they do add significant weight to the structure of the assembly, where the, for example, 2-inch ball valves used in the aeration lines can add a fair amount of extraneous weight to the assembly, during usage. This presents a weight problem and a drag upon the installation, and its operations. For example, the combination of a ball valve, of the type used in the prior art, and the various fittings that install it into the pressurized air line, can weigh as much as 4.7 lbs., per installation. This is significant particularly when the worker must locate underneath the tank trailer, or other vehicles, to make installation or changes to these types of instruments when used in the conveying and unloading of bulk materials.

In addition to the foregoing, usually a ball valve, when installed within a flow line, will reduce the capacity of the dimensions of the opening through which the material passes, or requires the installation of a larger sized bracketing means, for holding the valve in place, if the ball valve is to have an opening equivalent to the size of the flow line through which the air passes. With the current invention, this predicament is not encountered, since the offset disc valve of the current invention is not significant to reduce the size of the air line through which the pressurized air passes, during operation of the air line in inducing the flow of the granular material from the tank trailer during its discharge.

Obviously, there are many other types of valves that have been used in the prior art, even within pressurized air lines, but these valves are of an entirely different design, and require a different and substantial additional installation mechanics, to allow them to operate in the setting for the current invention in the tank trailer field.

Examples of the prior art style of valves, such as ball valves, can be seen in the U.S. Pat. No. 5,293,903, upon the T-connector for use in plumbing.

U.S. Pat. No. 5,110,191, shows a master cylinder with integrated supply regulator, having a valve therein.

Another example of a ball valve with built in check valve is shown in U.S. Pat. No. 4,846,221.

U.S. Pat. No. 4,077,673, shows a fluid pressure controlling device with a ball valve therein.

These are examples of some prior art style of valve mechanisms.

### SUMMARY OF THE INVENTION

The concept of this current invention is to provide a disc style of valve for use within an aeration line generally for application within a tank trailer system, to supply the pressurized air to the system to facilitate the unloading of granular material from its supply tank. The concept of this invention generally incorporates a series of improvements over those types of valve previously used for this purpose, and more specifically the ball style of valve as currently employed.

The advantages of this type of inventive valve, and its structure of operation, may be generally categorized as follows:
1. The butterfly valve is constructed having a thin line disc, such that when it is opened, it provides least resistance to the flow of air there passed.
2. The butterfly disc valve is of an offset design, so that when pivoted, the pivotal axis of the disc is offset or spaced from the axis of the pivot pins upon which the Butterfly valve attains its rotation.
3. An annular seal, one that is not interrupted in its extension circumferentially around the interior of the air flow line only slightly extends into the flow path, and therefore, allows for the Butterfly disc valve to fully seat entirely around its perimeter, with on the valve seat, to provide a full seal when closed.
4. Because the circumferential ring seal for the valve only slightly extends into the air flow path, it affords little or no interruption to the free flow of the pressurized air through the flow line, when the valve is opened and unloading of the granular material is performed.
5. The entire structure of this aeration butterfly disc valve, with the exception of its ring seal, is made of lightweight aluminum, and therefore, substantially reduces the weight of its structure from the type of ball valves currently used for this purpose within an air flow line.
6. A further feature of this invention is the various fittings that may be provided to allow for the inner connection of the aeration valve into the air flow line of the unloading system. For example, in one embodiment, the housing for the valve may include a series of externally arranged hosed barbs, on both of its hose adapters, which integrally extend away from, and in opposite directions, from the aeration valve disc. Thus, the two ends of the hoses may be simply press fit onto the external ends of the fittings, and be held in position by means of their integral barbs, to allow for the incoming air flow to pass through the butterfly valve, and in the direction towards the unloading grain or granular material to assure its further transfer. Or, one side of the valve housing may incorporate the external barb fittings, while the opposite end of the structure may have internal threads for providing the threaded engagement of the other hose to the valve, in preparation for its usage. Or, that same end of the housing may incorporate external male threads, for providing engagement of a hose connector thereto, when installing the valve in preparation for its usage. Or, it is also likely that each of the housing extensions may have internal threads, for interconnecting of male threads of the hose ends thereto, when the aeration valve is installed. These are all examples of the versatility of the aeration valve of this invention, and how it may be installed within the tank trailer air line, depending upon the pre-existing types of connectors, associated with the hoses, in which the valve needs to be installed.

The butterfly disc valve of the invention is installed within its housing. Essentially, the housing incorporates diametrically opposed channels therethrough, and it is within these channels that the bottom stem and the top stem of the pivot pins locate. These pivot pins are contoured for cooperating with upper and lower integrally extending pivot seats, into which the pins locate, so that the disc valve is capable of pivoting approximately ninety degrees, within the valve housing, and between its opened and closed positions, during its manipulation in preparation for usage, or shutoff. The butterfly disc of the valve is actually offset from the pivot axis of the located pivot pins, and that disc valve, because of its offset position, can be pivoted between its fully opened position, or pivoted 90 degrees into closure, providing a complete seal around the interior perimeter of the valve housing, when the butterfly valve is manipulated into closure. The uniqueness of this offset position for the butterfly valve disc is that it can enter into a full 360 degree seal, when it is turned into closure, with an internal circumferential seal provided around the interior of the housing, and since the pivot axis is displaced from the axis of rotation of the disc, there is no disruption in the seal as it enters into that 360 degree seal, upon the circumferential sealing ring seat, that mounts within the interior surface of the valve housing, as to be described.

The valve housing generally separates in the two parts. The two parts normally are threadily engaged together. At this location, a rubber, nylon, or other polymer ring is located between the two components of the housing, as they are threadily engaged together, and apply pressure onto the ring that compress it and wedges it into a dovetail engagement, and since it incorporates dovetail features, as machined into the housing components, when the seat is compressed, some part of the ring is displaced that flows inwardly of the interior diameter of the housing air path, and thereby provides a securely placed valve seat having a somewhat arcuate cross section that cannot get pulled free or torn by the valve disc, when the disc is opened and closed. The housing parts are made with shaped fittings and threads that are machined so that no additional fittings are required, in order to seal the valve seat in place, to cooperate with the outer perimeter or circumference of the butterfly disc, as it is pivoted into closure in full contact all the way around its circumference, when the aeration valve is closed.

As previously reviewed, the butterfly valve of this invention, at least for the 2-inch diameter type, only weighs approximately or less than 1.5 lbs., and thus, reduces the weight of the valve approximately three or more pounds from the ball style valve as currently used in the industry. This is significant for the purpose of reducing the weight of this component when assembled into the unloading mechanism of the tank trailer, where employed.

It is, therefore, the principal object of this invention to provide the application of a butterfly valve into the aeration valve means of a tank trailer unloading system.

Another object of this invention is to provide a butterfly valve, embodied within its housing, that may be made of aluminum or even a lightweight polymer, so as to substantially reduce the weight of this valve over the prior art types of air shutoff valves.

Still another object of this invention is to provide a butterfly disc valve that is offset from its pivot axis, to assure that a 365 degree seal may be made between the discs with its valve seat, when closed.

Still another object of this invention is to provide a two-part housing for a butterfly valve of this invention, wherein when the parts are engaged together, with its circumferential ring seal, provides a compressed seal that extends slightly inwardly of the inner diameter of the air line, to form a valve seat for the disc valve entirely around its perimeter, without any pivotal structure interference in the formed seal.

Still another object, in view of the foregoing, is to provide the sealing surface for the valve to be offset from the axis of rotation of the disc valve, so that the stem to disc connection of the valve does not need to be sealed.

A further object of this invention is to provide a valve disc that is contoured to provide for maximum flow area through the butterfly valve during its usage within an aeration line.

Still another object of this invention is to provide an aeration butterfly disc valve that may include various types of female or male, exterior or interior threaded or barbed connections, for accommodating the interconnection of the hose lines to the valve during their installation.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings,

FIG. 1 is a top view of the aeration butterfly valve of this invention;

FIG. 2 is a bottom view;

FIG. 3 is a left side view;

FIG. 4 is a right side view;

FIG. 5 is a front view;

FIG. 6 is a back view;

FIG. 7 is a top view of a modified aeration butterfly valve of this invention, providing for internal female pipe threads for its housing, on both ends, to accommodate the threaded connection of the hose end connectors therein during installation;

FIG. 8 is a bottom view;

FIG. 9 is a left side view;

FIG. 10 is a right side view;

FIG. 11 is a front view; and

FIG. 12 is a rear view; and

FIG. 13 is a top view of a modification to the aeration butterfly valve of this invention, showing the housing on both ends having barbed means for interconnection within the air line hose of the aeration device;

FIG. 14 is a bottom view;

FIG. 15 is a left side view;

FIG. 16 is a right side view;

FIG. 17 is a front view; and

FIG. 18 is a back view;

FIG. 19 is similar to the structure of the aeration valve of FIG. 7, having internal threads for connecting of the threaded ends of the hose connectors thereto;

FIG. 20 is a front view of the butterfly valve, with its disc valve maintained in enclosure;

FIG. 21 is a front view of the butterfly valve, with its disc valve pivoted 90 degrees into a fully opened position;

FIG. 22 is a sectional view of the butterfly valve taken along the line 22-22 of FIG. 20;

FIG. 23 is a sectional view of the butterfly valve taken along the line 23-23 of FIG. 20;

FIG. 24 is a sectional view showing the formation of the ring seal wedged between two parts of the valve housing as it is assembled, taken along the line 24-24 of FIG. 23;

FIG. 25 is a side view of the offset disc arrangement and its pivotal connection to the upper and lower pivot stems for the butterfly valve;

FIG. 26 is a front view of the disc valve and its pivotal stems taken along the line 26-26 of FIG. 25;

FIG. 27 is a sectional view of the interconnection of the pivotal stem with the integral extensions of the disc valve taken along the line 27-27 of FIG. 26; and

FIG. 28 is a top view of the butterfly disc valve at its mounting to the pivot stems, showing the range of its pivotal movement generally as shown for the structure in FIG. 25.

### DESCRIPTION OF THE PREFERRED EMBODIMENTS

In referring to the drawings, FIG. 1 shows the aeration butterfly valve 1 of this invention. In this embodiment, it includes an extended portion of the valve housing, as at 2, which includes a series of formed barbs 3, to allow for the proximate segment of any air line hose (not shown) to be pressure fitted thereon, to provide for connection of that end of the hose to the butterfly valve, during its installation. The opposite end of the housing, as at 4, may include a series of internal threads, to form the female connecting end of the housing, and into which the other end of the air line hose may be threadily engaged therein, when assembling the butterfly valve into the aeration hose system of the tank trailer. As to be noted, the butterfly valve housing includes a handle, as at 5, which can be turned approximately 90 degrees, as to be subsequently described, when opening or closing the aeration valve during operations of the system, particularly when unloading material from an accompanying tank trailer, or hopper car.

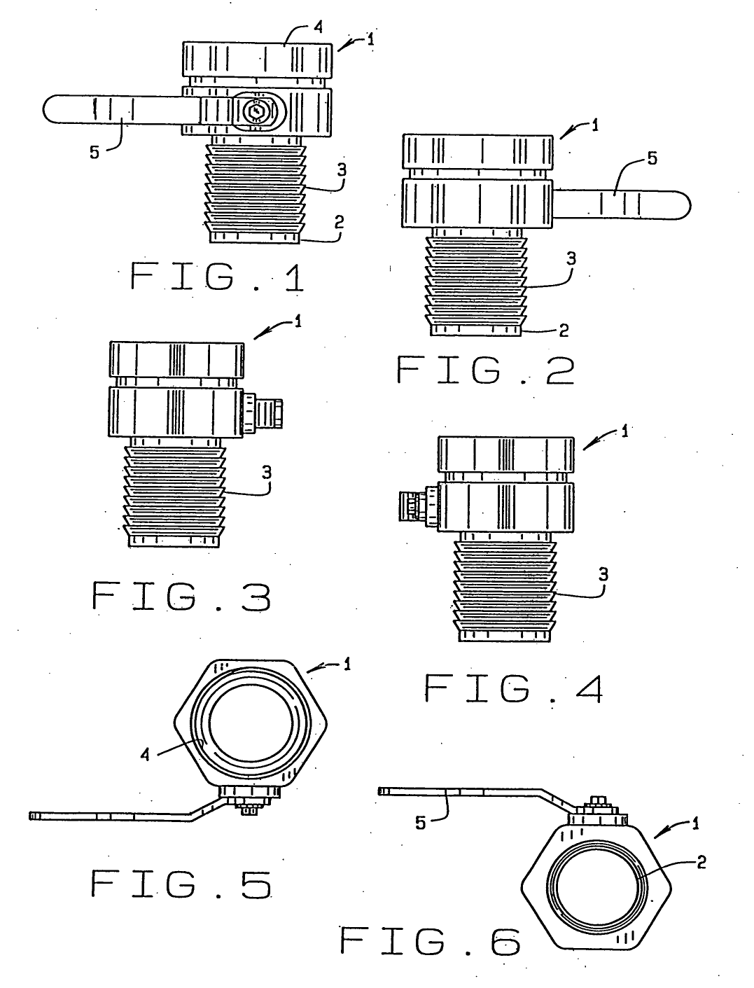

FIGS. 2-6 provide other views, of the aeration butterfly valve 1, as previously described in the description of the drawings segment of this application.

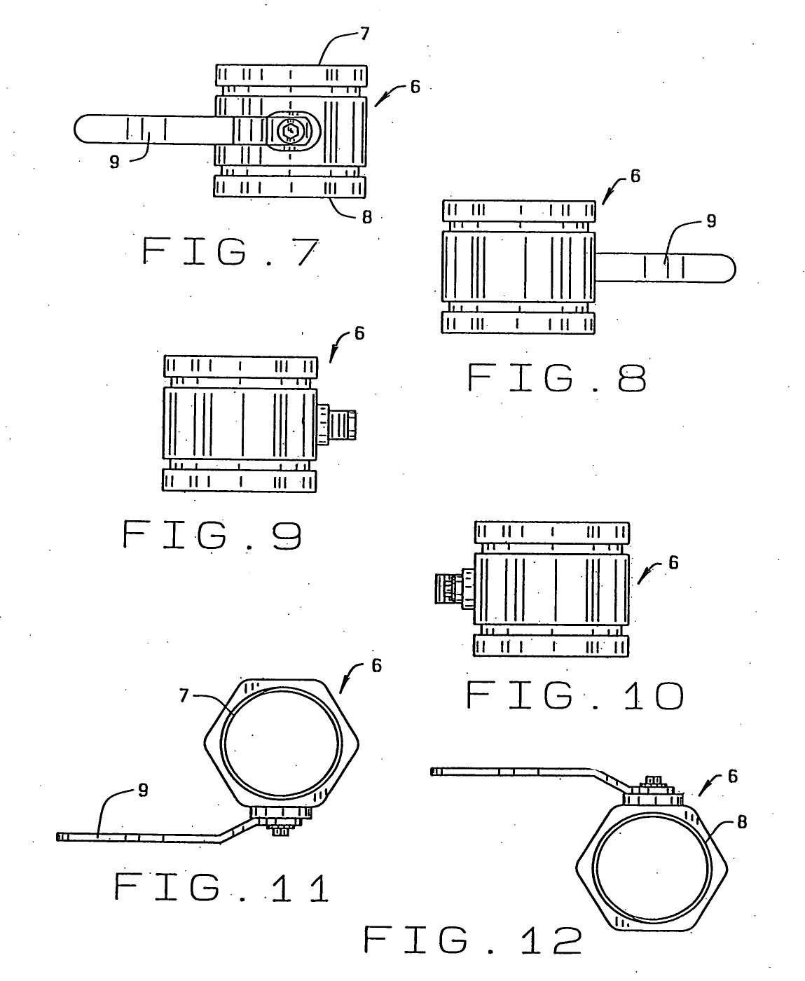

In referring to FIG. 7, therein is shown the aeration butterfly valve 6 in a modified construction. The housing includes, at each of its sides 7 and 8 internal threads, to allow for the threaded engagement of the proximate ends of the air line hose therein, to provide for sealed connection of the butterfly valve into the hose system, in preparation for its operations. Once again, the handle or lever 9 provides for the opening or closing of the valve, during its usage.

FIGS. 8-12 show additional views of the butterfly valve, as previously described in the brief description of the drawings herein.

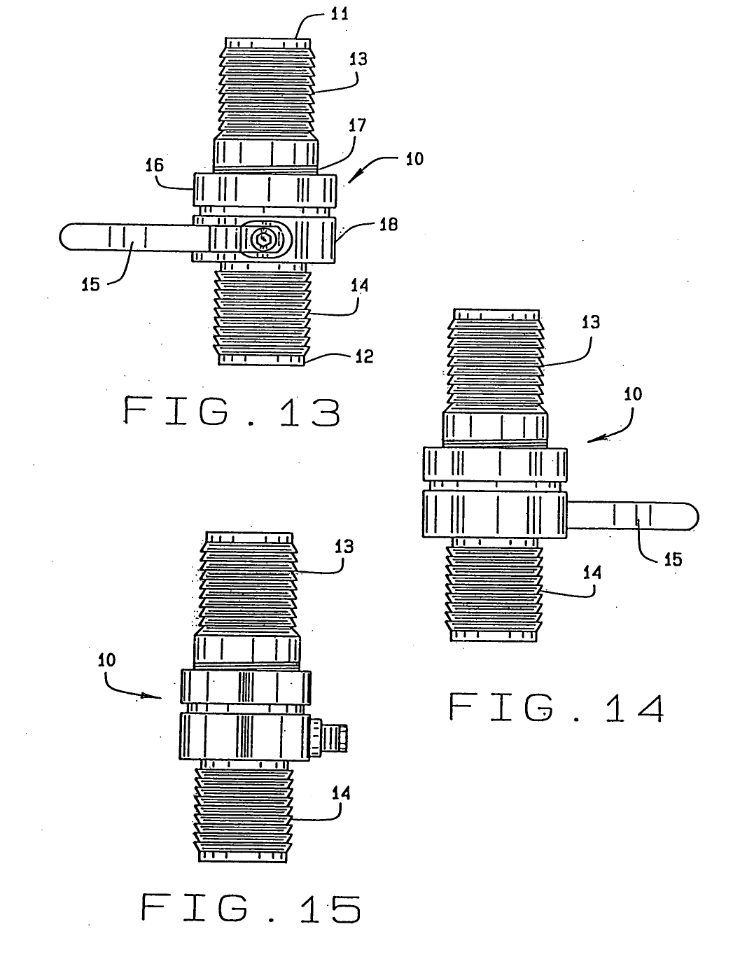

FIG. 13 discloses a further modified aeration butterfly valve 10 of this invention. In this particular embodiment, the two extensions 11 and 12 each incorporate their integrally formed barbs, as at 13 and 14, respectively, so that the proximate ends of the air line hose may be pressure fitted thereon, when this butterfly valve is installed within the aeration system, when assembled. Once again, a handle or lever 15 is shown, for providing for the manipulation of the valve between its opening and closed positions, during usage.

It should also be noted that the butterfly valve 10 may have a threaded engagement between its segment 11, and the part of the housing 16, as to be noted by the threads 17, or the segment 16 may threadily engage within the other part of its housing, as at 18, so as to provide for a compressive fit of a ring seal therein, to be subsequently described. Thus, the valve housing 10 preferably comes in two parts, so as to allow for the installation of its internally arranged circumferential seal, that seals the disc of the butterfly valve therein, when the aeration system is to be shut off, and pressurized air is to be precluded from flowing through the valve, after a material unloading operation.

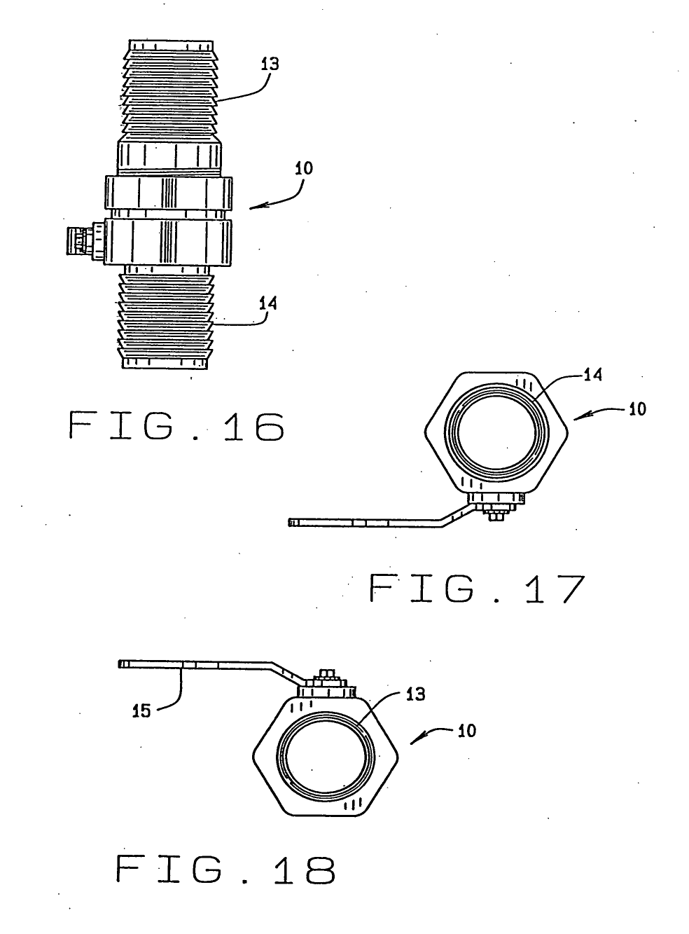

FIGS. 14-18 show other views of the aeration butterfly valve 10, as previously briefly described in the description of the drawings herein.

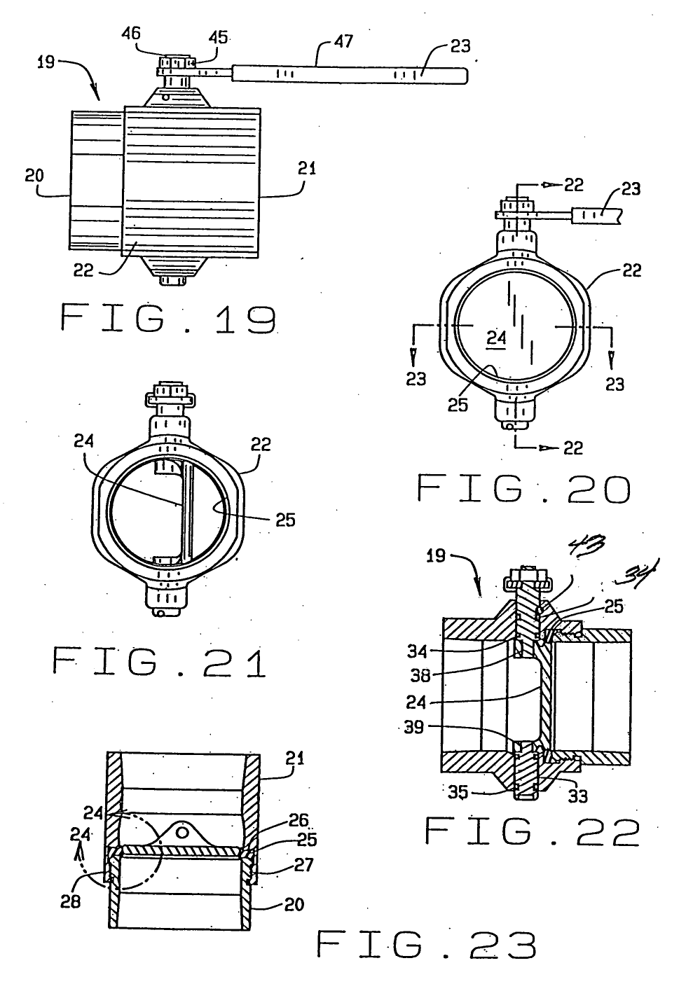

The internal arrangement of the operative components of the aeration butterfly valve of this invention can be more accurately seen within the various views of its parts as noted in FIGS. 19-28. While the valve 19 may show a type of valve that is similar in construction to the valve as previously described in FIG. 7, and that is, having internal female threads provided at both of its ends 20 and 21, the operative components of the valve may work just as well within the overall structure of the valves 1, 10, in addition to the valve 6, as previously described, as can be noted.

As can be seen, the butterfly valve includes its housing 22 and has its handle 23 provided for pivoting approximately 90 degrees, so as to turn its operatively associated butterfly disc valve 24 between its closed position, as noted in FIG. 20, and its opened location, as noted in FIG. 21, that allows for the pressurized air to pass freely therethrough, with a minimum of obstruction, due to the thin line configuration and construction of the disc 24, as can be noted in said FIG. 21. This pivoting between its closed position, and its opened position, is simply done through a 90 degree turn of its operatively associated handle 23, during its manipulation between the closed and opened conditions, depending upon the stage of its operation.

As previously referred to, internally of the butterfly valve housing 22 is an internal ring seal 25, as can be noted. This ring seal is installed into the housing by wedging it between the two threadedly connected parts 20 and 21 of the housing as previously referred to. As noted, each of these parts of the housing have slightly inclined internal edges 26 and 27, so that when the housing part 20 is threadily engaged, as at 28, the circumferential ring seal 25 becomes wedged therein, tightly embraced by the sloped ends of the two parts of the housing, as they threadily engage together, which causes a slight portion of the ring to bulge inwardly, as at 29, to provide a sealing surface upon which the disc 24 can engage in a pressure fit to seal the valve into closure, when in the position, as shown in FIG. 20. See also FIG. 24 for the location of the ring seal 25 when pressure fitted between the housing segments 20 and 21 when the two parts of the housing are threadily or otherwise engaged together, during assembly of the butterfly valve. As previously noted, this ring seal 25 may be formed of a rubber of a degree of durometer hardness that allows for it to function as a seal, when engaged by the valve disc, and to allow for its repeated engagement by the disc during usage of the system during multiple unloading procedures. In addition, such a seal may be formed of a rubber, a polymer, such as neoprene, silicone, or any other type of materials that can function effectively as an internal ring seal, for the valve, for a sustained useful life.

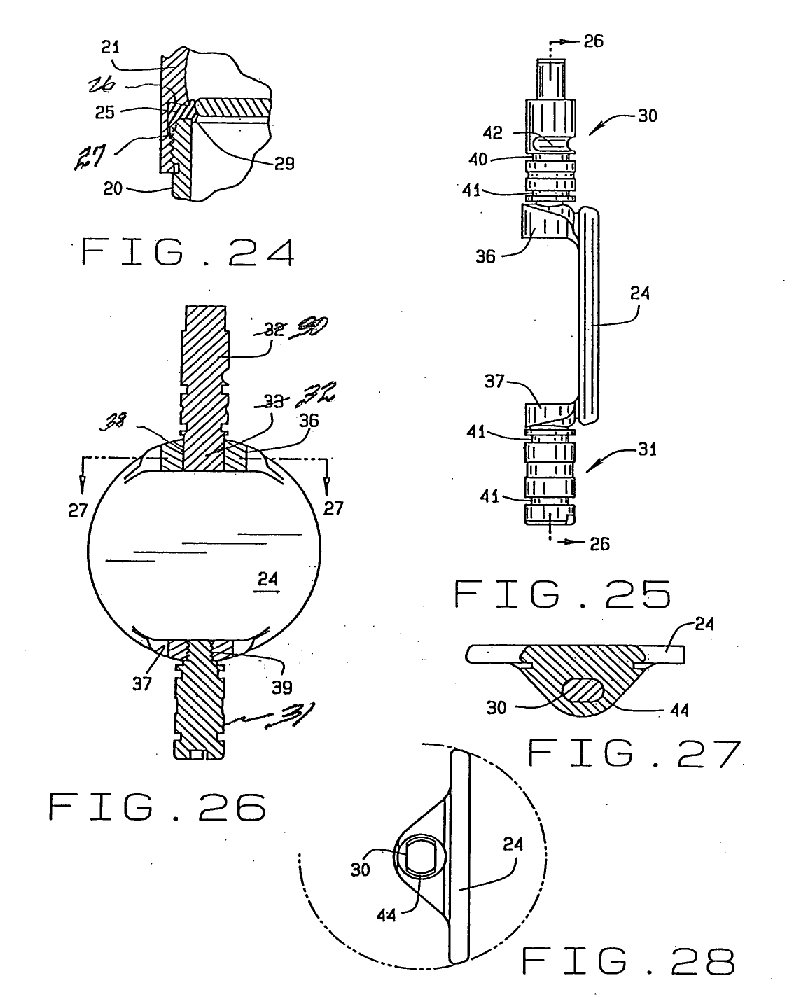

A significant aspect of this invention is the offset structure and arrangement of the valve disc 24 within the valve housing, as can generally be seen in FIG. 22. Its structure that forms the offset relationship between the disc 24, and its ring seal 25, can generally be seen for the aeration butterfly valve 19 as noted in FIG. 22. In addition, the specific offset structure of the disc 24, and its supporting pivotal structure, as at 30 for the upper pivot, and 31 for the lower pivot, can generally be noted in said FIGS. 25-28.

A significant aspect of this invention is the provision of a disc valve, generally of thin line construction, that has an offset axis of rotation separate from the pivot axis of rotation for the butterfly valve. Generally, this can be seen in FIG. 25. The disc valve 24 pivots on a different axis from the axis of rotation of the upper and lower valve stems 30 and 31, as can clearly be seen within this figure.

An upper aperture 32 and a lower aperture 33 are provided respectively through the valve housings, as can be noted. See again FIG. 22. These upper and lower pivot stems locate within these apertures, respectively, and a series of o-rings, as at 34 and 35, provide for the sealed arrangement of these upper and lower pivot stems for the valve in place.

As noted, the disc valve 24, as noted in FIG. 25, has integral extensions 36 and 37, and these extensions have apertures, as at 38 and 39, provided therethrough, and provides for a locating of the pivot points of the upper lower valve stems 32 and 33, to locate therein, and to allow for the pivot of the butterfly disc 24, about its own axis, as the handle 23 is turned, to force a turning of its pivot stem 32 through the contiguous housing of the valve, and to force a pivot of the disc valve 24, as can be noted.

As can be seen in FIG. 25, there are grooves provided, as generally at 40, and 41, and into which the o-rings 34 and 35, fit, respectively, to provide for the sealing location of the pivot stems within the housing, as can be noted. In addition, there is a clearance slot 42 that cooperates with a housing pin 43, which limits the extent of pivot to the butterfly disc 24, as it is manipulated between opening and closure. As previously stated, the disc valve is designed to provide for a full shutoff, by extending across the interior of the housing, and sealing fully upon its ring seal, when the valve is to be shut off, as noted in FIG. 20, but the butterfly disc is capable of being pivoted 90 degrees, to provide it in its fully opened position, as noted in FIG. 21. The clearance slot 42 provides for limits to pivot of the valve, approximately 90 degrees, in cooperating with the housing pin or detent 43, to furnish the limits of pivot of the disc valve 24, between these two open and closed conditions.

The bottom pivot stem 31 secures within the housing aperture 33, by any means of fastening, or it may be threadily engaged within the housing, so as to locate its extended pivot 39 for locating within the disc extension 37, to furnish a pivot point thereat. In addition, the upper pivot stem 30 locates within the housing aperture 32, and is generally fixed in position by means of the location of the pin 43 within the slot 42, that locks the upper pivot stem into position for pivot, but to prevent its escaping therefrom.

Furthermore, the upper pivot stem 30 has a lower end that locates within an elongated slot, as at 44 as for example, through a double D connection, as noted, or by any other shaped interconnection, so that the handle is capable of turning the upper pivot stem 30, at least 90 degrees, which provides for a 90 degree pivot of the butterfly disc 24, within the housing structure.

Furthermore, the handle 23 is held on to the various housings by means of a fastening jam nut 45 and there may be an additional retaining ring, such as a c-clamp 46 applied to the top of the pivot stem, to assure that the nut remains in place, and does not become loose.

It is significant, and needs to be emphasized herein, that one of the major aspects of this invention is to provide for that double axis of pivot, of the valve disc 24, with respect to the axis of pivot of the pivot stems 30 and 31, as can generally be seen and noted within FIG. 25. Hence, when the valve disc is pivoted, it pivots approximately 90 degrees, about its own axis, as can generally be noted in FIG. 28, and which axis is displaced, or separate, from the axis of rotation of the various pivot stems 30 and 31, as can also be seen from this FIG. 28. Thus, the entire outer perimeter of the disc valve 24 can be forced into complete circumferential contact with the inner ring seal 25, of the valve housing, when the butterfly valve 24 is forced into closure, in the position as noted for it in FIG. 20.

Also, it is to be noted that there may be a grip means, such as a polymer cover, as at 47, which may be applied to the handle or lever 23, to facilitate a gripping of the handle, during its manipulation.

Variations or modifications to the subject matter of this invention may occur to those skilled in the art upon review of the disclosure as provided herein. Such variations, if within the spirit of this invention, are intended to be encompassed within the scope of any claims to patent protection issuing hereon. The depiction of the invention in the drawings, and as explained in the description of the preferred embodiments, is generally set forth for illustrative purposes only.

I claim:

1. An aeration butterfly valve for use within an air line for facilitating the unloading of bulk material from a tank trailer or other vehicle, said valve incorporating a housing, said housing has an air passage therethrough, a valve disc located within said housing and capable of pivoting between a fully opened position, or into closure, said valve disc having an axis of pivot, upper and lower valve stems provided within the housing, and providing the means for pivoting of the valve disc, the axis of pivot of the valve disc and the axis of pivot of the pivot stems being axially aligned and with said valve disc being offset from the axis of pivot to provide for a concentric pivot of said valve disc with respect to the axis of pivot,
upper and lower extensions integrally connecting and extending from said valve disc, said extensions pivotally connecting upon the upper and lower valve stems, to provide for the concentric pivot for the valve disc offset from the axis of pivot of the valve stems during opening and closure of the aeration butterfly valve;
said valve housing separates into a first valve housing part and a second valve housing part, one of said valve housing parts engaging within the other valve housing part, each said first and second valve housing parts having inner edges, and a ring seal provided intermediate the inner edges of the connected valve housing parts and pressed therein and into the air passage to form a ring seal for circumferentially engaging the entire outer periphery of the valve disc when it is pivoted and sealed into closure, said inner edges of the valve housing parts have inclined internal edges, which when the valve housing parts are engaged together, the inclined edges form a dovetailed engagement that applies pressure to the ring seal for some part of the ring to be slightly compressed and forced inwardly of the interior diameter of the housing air path and thereby provide a seal seat against which the outer perimeter of the valve disc fully engages into sealed closure;
one of said valve housing parts threadedly engages within the second valve housing part;
said upper pivot stem incorporates a clearance slot, a detent operatively associated with the valve housing, and located within the clearance slot, to limit the extent of pivotal movement of the valve disc within the housing during its manipulation between opening and closure;
said upper extension from the valve disc incorporates an elongated slot, and the pivot stem located within said elongated slot to provide for turning of the valve disc between its opening and closed positions; and
wherein said first and second valve housing parts extend away from the valve disc, and each of said housing parts incorporating one of barbs, external and internal threads, to provide for interconnection of the air line thereto when the aeration butterfly valve disc is installed within an airline in preparation for its usage.
